(19) United States
(12) Patent Application Publication
(10) Pub. No.: US 2015/0089446 A1
(43) Pub. Date: Mar. 26, 2015

(54) PROVIDING CONTROL POINTS IN IMAGES

(71) Applicant: Google Inc., Mountain View, CA (US)

(72) Inventors: Gavin James, Los Angeles, CA (US); Justin Lewis, Marina del Rey, CA (US)

(21) Appl. No.: 14/035,764

(22) Filed: Sep. 24, 2013

(51) Int. Cl. G06F 3/0484

(52) U.S. Cl. CPC G06F 3/04845; G06F 3/04842
USPC 715/810

(57) ABSTRACT

Implementations generally relate to providing control points in images. In some implementations, a method includes determining one or more control points in an image. The method also includes determining one or more image manipulation transforms corresponding to each control point. The method also includes providing the one or more control points and the one or more corresponding image manipulation transforms to a user.

### BACKGROUND

The popularity and convenience of digital cameras as well as the widespread of use of Internet communications have caused user-produced images such as photographs to become ubiquitous. Image editing systems for various consumer electronic devices and personal computers enable a user to manipulate images. Such image editing systems typically require the user to understand complicated and difficult instructions to manipulate the image. This level of knowledge places advanced editing features out of the grasp of the average user.

### SUMMARY

Implementations generally relate to providing control points in images. In some implementations, a method includes determining one or more control points in an image. The method also includes determining one or more image manipulation transforms corresponding to each control point. The method also includes providing the one or more control points and the one or more corresponding image manipulation transforms to a user.

With further regard to the method, in some implementations, the determining of the one or more control points includes: selecting one or more regions in the image; and associating one or more control points with each selected region. In some implementations, the determining of the one or more control points includes: selecting one or more regions in the image; determining a region type for each region; and associating one or more control points with at least one region based on the region type. In some implementations, the determining of one or more of the control points in the image is based on image recognition. In some implementations, the one or more image manipulation transforms include one or more filters. In some implementations, the one or more image manipulation transforms include one or more two-dimensional transforms. In some implementations, the one or more image manipulation transforms include one or more three-dimensional transforms. In some implementations, the method further includes enabling the user to select one or more of the control points for the image. In some implementations, the method further includes enabling the user to select one or more of the control points for the image; and enabling the user to select one or more image manipulation transforms for each control point.

In some implementations, a method includes determining one or more control points in an image. In some implementations, the determining of the one or more control points includes: selecting one or more regions in the image; and associating one or more control points with each selected region. The method further includes determining one or more image manipulation transforms corresponding to each control point, where the one or more image manipulation transforms include one or more filters. The method further includes providing the one or more control points and the one or more corresponding image manipulation transforms to a user. The method further includes enabling the user to select one or more of the control points for the image and to select one or more image manipulation transforms for each control point.

With further regard to the method, in some implementations, the determining of one or more of the control points in the image is based on image recognition. In some implementations, the one or more image manipulation transforms include one or more two-dimensional transforms. In some implementations, the one or more image manipulation transforms include one or more three-dimensional transforms.

In some implementations, a system includes one or more processors, and logic encoded in one or more tangible media for execution by the one or more processors. When executed, the logic is operable to perform operations including: determining one or more control points in an image; determining one or more image manipulation transforms corresponding to each control point; and providing the one or more control points and the one or more corresponding image manipulation transforms to a user.

With further regard to the system, in some implementations, to determine the one or more control points, the logic when executed is further operable to perform operations including: selecting one or more regions in the image; and associating one or more control points with each selected region. In some implementations, to determine the one or more control points, the logic when executed is further operable to perform operations including: selecting one or more regions in the image; determining a region type for each region; and associating one or more control points with at least one region based on the region type. In some implementations, the logic when executed is further operable to perform operations including determining the one or more of the control points in the image based on image recognition. In some implementations, the one or more image manipulation transforms include one or more filters. In some implementations, the one or more image manipulation transforms include one or more two-dimensional transforms. In some implementations, the one or more image manipulation transforms include one or more three-dimensional transforms.

### BRIEF DESCRIPTION OF THE DRAWINGS

FIG. 1 illustrates a block diagram of an example network environment, which may be used to implement the implementations described herein.

FIG. 2 illustrates an example simplified flow diagram for enabling a user to modify images, according to some implementations.

FIG. 3 illustrates an example simplified user interface, according to some implementations.

FIG. 4 illustrates a block diagram of an example server device, which may be used to implement the implementations described herein.

### DETAILED DESCRIPTION

Implementations for providing control points in digital images are described. In various implementations, a system determines one or more control points in an image. In various implementations, a control point enables a user to quickly and intuitively make selective adjustments or enhancements to images. Control points enable a user to make such modifications to an image without needing to create, in an image editing interface, complex selections, masks, layers, etc.

In some implementations, to determine the one or more control points, the system selects one or more regions in the image, and associates one or more control points with each selected region. In some implementations, to determine the one or more control points, the system selects one or more regions in the image, determines a region type for each region, and associates one or more control points with each selected region based on the region type. In some implementations, the system determines one or more of the control points in the image based on image recognition.

The system then determines one or more image manipulation transforms corresponding to each control point. In some implementations, the one or more image manipulation transforms include one or more filters. In some implementations, the one or more image manipulation transforms include one or more n-dimensional transforms (e.g., two-dimensional transforms, three-dimensional transforms, etc.). In some implementations, the system determines a region type for each region, and then determines one or more image manipulation transforms corresponding to each control point based on the region type.

The system then provides the one or more control points and the one or more corresponding image manipulation transforms to a user. The system then enables the user to select one or more of the control points for the image, and to select one or more image manipulation transforms for each control point.

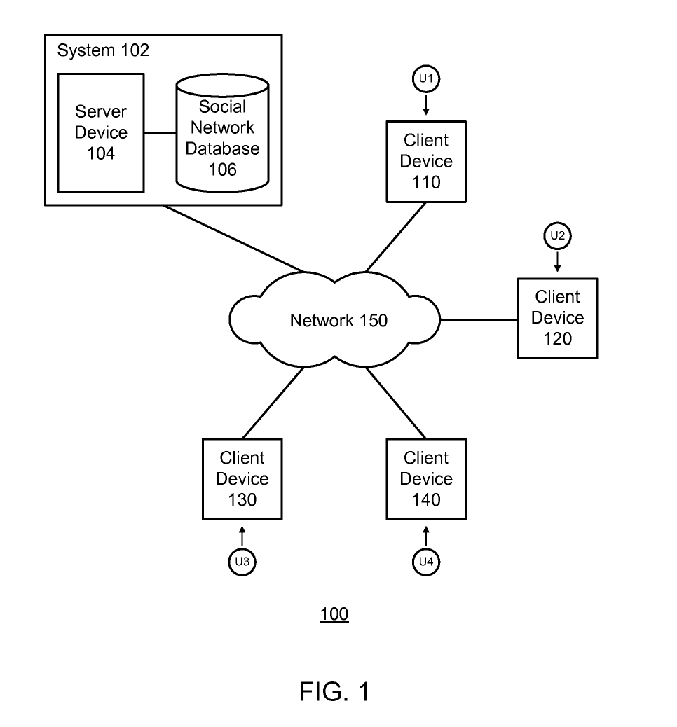

FIG. 1 illustrates a block diagram of an example network environment 100, which may be used to implement the implementations described herein. In some implementations, network environment 100 includes a system 102, which includes a server device 104 and a social network database 106. In various implementations, the term system 102 and phrase “social network system” may be used interchangeably. Network environment 100 also includes client devices 110, 120, 130, and 140, which may communicate with each other via system 102. Network environment 100 also includes a network 150.

For ease of illustration, FIG. 1 shows one block for each of system 102, server device 104, and social network database 106, and shows four blocks for client devices 110, 120, 130, and 140. Blocks 102, 104, and 106 may represent multiple systems, server devices, and social network databases. Also, there may be any number of client devices. In other implementations, network environment 100 may not have all of the components shown and/or may have other elements including other types of elements instead of, or in addition to, those shown herein.

In various implementations, users U1, U2, U3, and U4 may communicate with each other using respective client devices 110, 120, 130, and 140. For example, users U1, U2, U3, and U4 may interact with each other and with system 102, where respective client devices 110, 120, 130, and 140 transmit media items such as photos to each other and to system 102.

In the various implementations described herein, processor of system 102 causes the elements described herein (e.g., control points, image manipulation transforms, etc.) to be displayed in a user interface on one or more display screens.

In various implementations, system 102 may utilize a recognition algorithm to facilitate in determining control points and image manipulation transforms. Example implementations of recognition algorithms are described in more detail below.

While some implementations are described herein in the context of a social network system, these implementations may apply in contexts other than a social network. For example, implementations may apply locally for an individual user. For example, system 102 may perform the implementations described herein on a stand-alone computer, tablet computer, smartphone, etc.

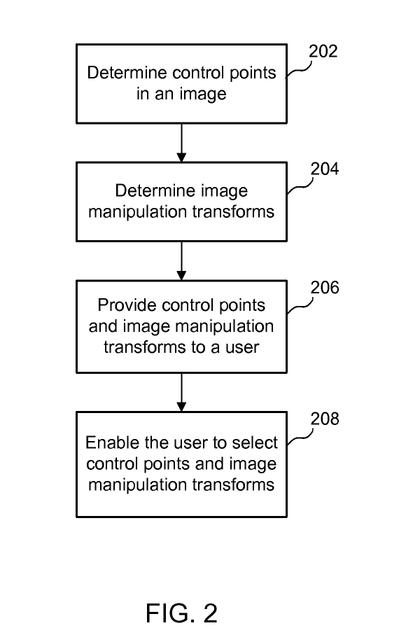

FIG. 2 illustrates an example simplified flow diagram for enabling a user to modify images, according to some implementations. Referring to both FIGS. 1 and 2, a method is initiated in block 202, where system 102 determines one or more control points in an image. In various implementations, system 102 may obtain the image after the user uploads images to system 102 or after the user adds the images to one or more photo albums. In some implementations, system 102 may enable a camera device (e.g., smart phone) of the user to automatically upload images to system 102 as the camera device captures photos.

As indicated above, control points enable a user to quickly and intuitively make selective adjustments or enhancements to images. As described in more detail below, control points enable a user to make such modifications to specific portions of an image without needing to create complex selections, masks, layers, etc. in specialized image editing software.

In various implementations, system 102 may determine one or more of the control points in the image based on image recognition. For example, in some implementations, to determine the one or more control points, system 102 may select one or more regions in the image. In various implementations, system 102 identifies key regions (e.g., faces, landmarks, and other recognizable objects, cats, etc.) including background regions. Such regions may include one or more objects. In some implementations, system 102 may determine regions as key regions because they are in focus or positioned in a prominent portion of an image (e.g., in the center of the image).

System 102 may utilize a recognition algorithm to identify and isolate particular/key regions in the image. For example, as indicated above, system 102 may recognize a face, a landmark, etc. in an image. Example implementations of recognition algorithms are described in more detail below.

In various implementations, system 102 determines a region type for each region. As described in more detail below, in various implementations, the region type is based on the content within the region. In some implementations, system 102 may determine the region type for each region based on image recognition. For example, system 102 may determine that a given object is a face. System 102 may recognize objects or features such as eyes, a nose, a mouth, etc. as a face region. System 102 may recognize a face and its features as foreground regions in an image. System 102 may recognize some objects as landmark regions. System 102 may recognize landmarks and other objects as background regions in an image. System 102 may recognize people and animals as people and animal regions. System 102 may recognize trees, plants and other objects as landscape regions. System 102 may recognize a sky or body of water as sky or water regions. The particular region types and number of region types will depend on the particular implementation. In some implementations, system 102 may generate masks for the selected region elements, and then add all of the masks to a list.

In various implementations, system 102 associates one or more control points with each selected region. In various implementations, system 102 associates each control point with the region type. For example, system 102 may associate a control point with a face region. System 102 may associate a control point with all foreground regions. System 102 may associate a control point with all background regions. System 102 may make such associations with any region described herein, and others (e.g., backlit subject, reflective surface, etc.). The particular association and number of associations will depend on the particular implementation. System 102 automatically associates control points with select regions so as to eliminate the need for the user to manually make such associations.

In block 204, system 102 determines one or more image manipulation transforms corresponding to each control point. In some implementations, the one or more image manipulation transforms may include one or more predefined and/or custom filters. For example, such filters may include filters that blur, sharpen, soften and image. Filters may also modify brightness, contrast, etc. Filters may also perform luminance equalization, gamma correction, color depth modification, etc.

In various implementations, to determine the image manipulation transforms corresponding to each control point, system 102 may select pre-made transforms and/or transforms previously generate by system 102. As described above, system 102 determines particular regions in the image and determines a region type for each region (e.g., a face, a landmark, etc.). In various implementations, system 102 selects image manipulation transforms (e.g., types of filters) that are relevant and/or appropriate for each region based on the region type. For example, image manipulation transforms involving ambient blur, depth of field effect, etc., might be appropriate for background regions but might not be appropriate for other regions such as regions that include people in the foreground. In some implementations, an image manipulation transform may provide a drama filter that enhances the clouds in a sky region. In some implementations, an image manipulation transform may enhance the contrast, color correct, etc., for a landmark. In some implementations, an image manipulation transform may smoothen skin, remove wrinkles, remove blemishes, etc.

In an example scenario, system 102 may identify a face region and generate a control point for the face region. System 102 may then select one or more image manipulation transform that best suits a face region. For example, system 102 may select a skin smoothing filter, a wrinkle removing filter, a blemish removing filter, etc. and associate such filters with that particular control point. System 102 might not select a depth of field effect filter for the control point because that particular type of filter might not be appropriate for a face region. Automatically selecting particular image manipulation transforms for each control point based on region type eliminates the need for the user to figure out which image manipulation transforms are appropriate for each region.

In some implementations, an image manipulation transform may extract details of other images and apply those details to a target image in order to enhance the image. For example, there may be multiple images of a face, where the eyes are open in some images but not others, or where the person is smiling in some images but not in others. An image manipulation transform may ensure that for a given image, a person is smiling with eyes open by extracting the desired details (e.g., open eyes, smiling mouth, etc.) from some images and applying those details to a target image.

In various implementations, system 102 may generate multiple control points for a given region. For example, system 102 may generate multiple control points for a face region, where the control points overlap, yet each control point corresponds to a different subregion. For example, a control point may be associated with the entire face, a control point may be associated with the eyes of the face, and a control point may be associated with the teeth. In various implementations, system 102 may selectively apply image manipulation transforms (e.g., to the face but not the eyes and teeth). For example, one control point may edit/update the face with skin smoothing, remove wrinkles and blemishes, etc., but not run the algorithmic filter over the eyes and teeth. Another control point may apply only to the eyes (e.g., red eye correction). Another control point may apply onto to the teeth (e.g., teeth whitening). In some implementations, if user selects the face, system 102 may apply all control points associated with the entire face region (e.g., face, eyes, teeth, etc.). In various implementations, system 102 may determine default transform settings (e.g., filter settings) based on the type of region.

In various implementations, image manipulation transforms are not limited to regular color and contrast adjustments. In some implementations, the one or more image manipulation transforms may include one or more two-dimensional transforms. For example, a given image manipulation transform may include filters that scale and/or distort the image. For example, an image manipulation transform may include a “bug eye” filter that makes a person's eyes look humongous. System 102 may use a face recognition algorithm to place a control point over the face to select just the eyes, where a bug eye filter is made available to the user for selection. In some implementations, as an example of an editing flow, such filters may be placed any time the user selects a filter. As such, there is no need to save the bug-eye control point in advance, it can be generated when the bug-eye filter is activated. Similarly, in some implementations, a tooth whitening filter may be placed algorithmically when the filter is selected.

In some implementations, image manipulation transform may be chosen either manually or by machine learning. Likewise, the initial settings for the control points (even those that have been manually placed) can be given as defaults or adjusted by machine learning, potentially on a per-user basis.

In some implementations, the one or more image manipulation transforms may include one or more three-dimensional transforms. For example, in some implementations, system 102 may build a three-dimensional (3D) model out of a portion of an image. For example, system 102 may build a 3D model of a telescope in an image, where a software application maps the pixels of the image onto the 3D model. An image manipulation transform may manipulate how the telescope appears in the image (e.g., face a different direction, rotate, scale, etc.).

In some implementations, an image manipulation transform may reposition objects in an image. For example, in some implementations, an image manipulation transform may move a distracting foreground object into the background, scale down the element, or remove the element completely. Such a distracting object may be a person walking through a landscape scene, where the user might not want the person to appear in the image.

In block 206, system 102 provides the one or more control points and the one or more corresponding image manipulation transforms to a user. In various implementations, system 102 may automatically display images with control points or may enable the user to toggle the control points on and off. In other words, images may simply appear to users with the control points already existing.

In various implementations, system 102 may provide the user with a user interface, where system 102 causes one or more control points and one or more controls to be displayed in the user interface, where the controls are for applying corresponding image manipulation transforms to a given image. The particular graphical representations of the control points and controls (e.g., filter controls), and corresponding selection buttons may vary and will depend on the particular implementation. For example, in some implementations, system 102 may provide a list of control points in the user interface with a visual indication as to which region or regions each control point applies. System 102 may also provide a list of corresponding controls (e.g., for image manipulation transforms) in the user interface with a visual indication of which control points are associated with each control.

In various implementations, system 102 may identify particular locations in an image, position each control point in the image, and cause a representation of a control point to be positioned over or next to the associated region of the image. In some implementations, system 102 may indicate a particular region by masking over the pixels of the region (e.g., blocking out, graying out, etc.). In some implementations, system 102 may position a given control point in the center of a mask. In various implementations, the control point may be the whole mask or offset such that the control points are easy to individually select. System 102 may also display a dotted line around the pixels of the region. The particular type of indication will depend on the particular implementation.

In various implementations, system 102 may display control points and image manipulation transforms in various ways. For example, system 102 may display the control points and corresponding image manipulation transforms simultaneously in the user interface. In some implementations, system 102 may enable the user to first select a control point. After the user selects a control point, system 102 may then display a list of appropriate filters and settings controls for filters.

In block 208, system 102 enables the user to select one or more of the control points for the image, and to select one or more image manipulation transforms for each control point. In some implementations, system 102 may display, to the user, the photo with the control points as interactive elements. System 102 may cause selection buttons to be displayed in the user interface, where the user can select such buttons corresponding to control points and image manipulation transforms. In various implementations, a given selection button may toggle a control point on and off. Similarly, a given selection button may toggle an image manipulation transform on and off. In some implementations, system 102 enables the user to use the controls to adjust filter settings (e.g., in real time), apply filters, and then save an image. As a result, the user can quickly apply specific edits (e.g., applying specific image manipulation transforms) to specific regions in an image.

In some implementations, system 102 may select and associate a given control point with non-contiguous (e.g., non-touching) regions. For example, system 102 may define a particular region as including all people in the foreground of an image, where some people may be separate (e.g., not touching or overlapping) other people. System 102 may associate a control with all the people in the foreground. As such, system 102 may determine one or more image manipulation transforms for that region, which may include all the people in the foreground. System 102 may then provide those control points and corresponding image manipulation transforms to the region.

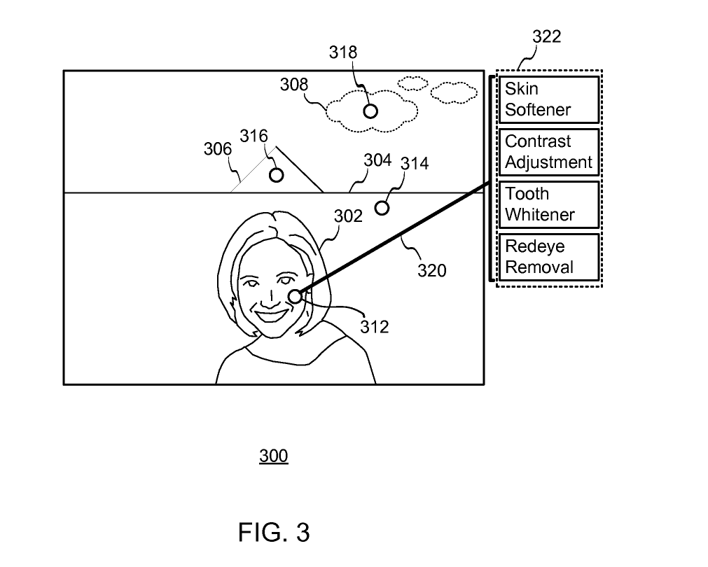

FIG. 3 illustrates an example simplified user interface 300, according to some implementations. As shown, user interface 300 shows an image of a person 302 in the foreground and a desert landscape 304, pyramid 306, and clouds 308 in the background.

As described in various implementations herein, system 102 automatically generates control points and positions the controls close to or overlapping associated regions. For example, as shown a control point 312 is positioned over the face region of person 302, a control point 314 is positioned over a desert landscape 304, a control point 316 is positioned over pyramid 306, and a control point 318 is positioned over cloud 308.

As described herein, in some implementations, system 102 may initially cause control points to be displayed without the corresponding controls (representing image manipulation transforms). When the user selects a given control point, system 102 then displays the corresponding controls. For example, as shown, after the user selects control point 312, a line indicator 320 indicates a set of controls 322 that correspond to control point 312.

In this example implementation, each of the controls 322 corresponds to an image manipulation transform. As shown, such image manipulation transforms may include a skin softener filter, a contrast adjustment filter, a tooth whitener filter, and a redeye removal filter. The particular controls will vary, depending on the particular implementation.

Implementations described herein provide various benefits. For example, implementations enable users to modify or enhance images without having much experience or expertise in manipulating images. Implementations described herein also increase overall engagement among users in modifying or enhancing images by simplifying the user experience.

Although the steps, operations, or computations may be presented in a specific order, the order may be changed in particular implementations. Other orderings of the steps are possible, depending on the particular implementation. In some particular implementations, multiple steps shown as sequential in this specification may be performed at the same time. Also, some implementations may not have all of the steps shown and/or may have other steps instead of, or in addition to, those shown herein.

While system 102 is described as performing the steps as described in the implementations herein, any suitable component or combination of components of system 102 or any suitable processor or processors associated with system 102 may perform the steps described.

In various implementations, system 102 may utilize a variety of recognition algorithms to recognize faces, landmarks, objects, etc. in images. Such recognition algorithms may be integral to system 102. System 102 may also access recognition algorithms provided by software that is external to system 102 and that system 102 accesses.

In various implementations, system 102 enables users of the social network system to specify and/or consent to the use of personal information, which may include system 102 using their faces in images or using their identity information in recognizing people identified in images. For example, system 102 may provide users with multiple selections directed to specifying and/or consenting to the use of personal information. For example, selections with regard to specifying and/or consenting may be associated with individual images, all images, individual photo albums, all photo albums, etc. The selections may be implemented in a variety of ways. For example, system 102 may cause buttons or check boxes to be displayed next to various selections. In some implementations, system 102 enables users of the social network to specify and/or consent to the use of using their images for facial recognition in general. Example implementations for recognizing faces and other objects are described in more detail below.

In situations in which the systems discussed here collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

In various implementations, system 102 obtains reference images of users of the social network system, where each reference image includes an image of a face that is associated with a known user. The user is known, in that system 102 has the user's identity information such as the user's name and other profile information. In some implementations, a reference image may be, for example, a profile image that the user has uploaded. In some implementations, a reference image may be based on a composite of a group of reference images.

In some implementations, to recognize a face in an image, system 102 may compare the face (e.g., image of the face) and match the face to reference images of users of the social network system. Note that the term “face” and the phrase “image of the face” are used interchangeably. For ease of illustration, the recognition of one face is described in some of the example implementations described herein. These implementations may also apply to each face of multiple faces to be recognized.

In some implementations, system 102 may search reference images in order to identify any one or more reference images that are similar to the face in the image. In some implementations, for a given reference image, system 102 may extract features from the image of the face in an image for analysis, and then compare those features to those of one or more reference images. For example, system 102 may analyze the relative position, size, and/or shape of facial features such as eyes, nose, cheekbones, mouth, jaw, etc. In some implementations, system 102 may use data gathered from the analysis to match the face in the image to one more reference images with matching or similar features. In some implementations, system 102 may normalize multiple reference images, and compress face data from those images into a composite representation having information (e.g., facial feature data), and then compare the face in the image to the composite representation for facial recognition.

In some scenarios, the face in the image may be similar to multiple reference images associated with the same user. As such, there would be a high probability that the person associated with the face in the image is the same person associated with the reference images.

In some scenarios, the face in the image may be similar to multiple reference images associated with different users. As such, there would be a moderately high yet decreased probability that the person in the image matches any given person associated with the reference images. To handle such a situation, system 102 may use various types of facial recognition algorithms to narrow the possibilities, ideally down to one best candidate.

For example, in some implementations, to facilitate in facial recognition, system 102 may use geometric facial recognition algorithms, which are based on feature discrimination. System 102 may also use photometric algorithms, which are based on a statistical approach that distills a facial feature into values for comparison. A combination of the geometric and photometric approaches could also be used when comparing the face in the image to one or more references.

Other facial recognition algorithms may be used. For example, system 102 may use facial recognition algorithms that use one or more of principal component analysis, linear discriminate analysis, elastic bunch graph matching, hidden Markov models, and dynamic link matching. It will be appreciated that system 102 may use other known or later developed facial recognition algorithms, techniques, and/or systems.

In some implementations, system 102 may generate an output indicating a likelihood (or probability) that the face in the image matches a given reference image. In some implementations, the output may be represented as a metric (or numerical value) such as a percentage associated with the confidence that the face in the image matches a given reference image. For example, a value of 1.0 may represent 100% confidence of a match. This could occur, for example, when compared images are identical or nearly identical. The value could be lower, for example 0.5 when there is a 50% chance of a match. Other types of outputs are possible. For example, in some implementations, the output may be a confidence score for matching.

For ease of illustration, some example implementations described above have been described in the context of a facial recognition algorithm. Other similar recognition algorithms and/or visual search systems may be used to recognize objects such as landmarks, logos, entities, events, etc. in order to implement implementations described herein.

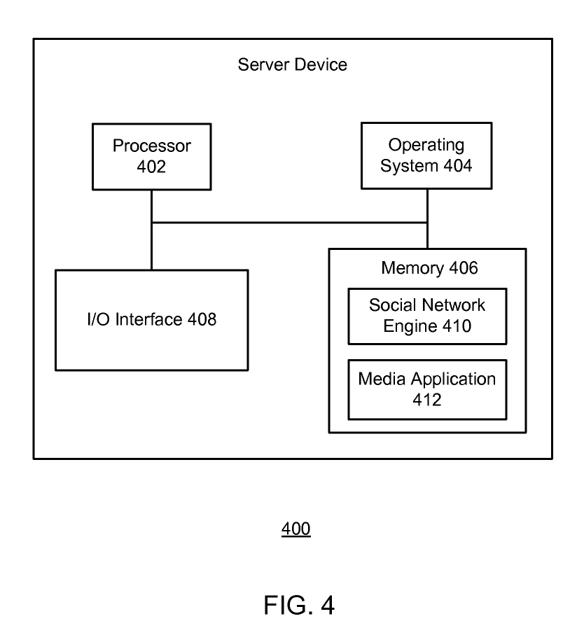

FIG. 4 illustrates a block diagram of an example server device 400, which may be used to implement the implementations described herein. For example, server device 400 may be used to implement server device 104 of FIG. 1, as well as to perform the method implementations described herein. In some implementations, server device 400 includes a processor 402, an operating system 404, a memory 406, and an input/output (I/O) interface 408. Server device 400 also includes a social network engine 410 and a media application 412, which may be stored in memory 406 or on any other suitable storage location or computer-readable medium. Media application 412 provides instructions that enable processor 402 to perform the functions described herein and other functions.

For ease of illustration, FIG. 4 shows one block for each of processor 402, operating system 404, memory 406, I/O interface 408, social network engine 410, and media application 412. These blocks 402, 404, 406, 408, 410, and 412 may represent multiple processors, operating systems, memories, I/O interfaces, social network engines, and media applications. In other implementations, server device 400 may not have all of the components shown and/or may have other elements including other types of elements instead of, or in addition to, those shown herein.

Although the description has been described with respect to particular embodiments thereof, these particular embodiments are merely illustrative, and not restrictive. Concepts illustrated in the examples may be applied to other examples and implementations. For example, some implementations are described herein in the context of a social network system. However, the implementations described herein may apply in contexts other than a social network. For example, implementations may apply locally for an individual user.

Note that the functional blocks, methods, devices, and systems described in the present disclosure may be integrated or divided into different combinations of systems, devices, and functional blocks as would be known to those skilled in the art.

Any suitable programming languages and programming techniques may be used to implement the routines of particular embodiments. Different programming techniques may be employed such as procedural or object-oriented. The routines may execute on a single processing device or multiple processors. Although the steps, operations, or computations may be presented in a specific order, the order may be changed in different particular embodiments. In some particular embodiments, multiple steps shown as sequential in this specification may be performed at the same time.

A “processor” includes any suitable hardware and/or software system, mechanism or component that processes data, signals or other information. A processor may include a system with a general-purpose central processing unit, multiple processing units, dedicated circuitry for achieving functionality, or other systems. Processing need not be limited to a geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory. The memory may be any suitable data storage, memory and/or non-transitory computer-readable storage medium, including electronic storage devices such as random-access memory (RAM), read-only memory (ROM), magnetic storage device (hard disk drive or the like), flash, optical storage device (CD, DVD or the like), magnetic or optical disk, or other tangible media suitable for storing instructions for execution by the processor. The software instructions can also be contained in, and provided as, an electronic signal, for example in the form of software as a service (SaaS) delivered from a server (e.g., a distributed system and/or a cloud computing system).

What is claimed is:

1. A method comprising:
determining one or more control points in an image, wherein the determining of the one or more control points includes:
selecting one or more regions in the image; and
associating one or more control points with each selected region;
determining one or more image manipulation transforms corresponding to each control point, wherein the one or more image manipulation transforms include one or more filters;
providing the one or more control points and the one or more corresponding image manipulation transforms to a user; and
enabling the user to select one or more of the control points for the image and to select one or more image manipulation transforms for each control point.

2. The method of claim 1, wherein the determining of one or more of the control points in the image is based on image recognition.

3. The method of claim 1, wherein the one or more image manipulation transforms comprise one or more two-dimensional transforms.

4. The method of claim 1, wherein the one or more image manipulation transforms comprise one or more three-dimensional transforms.

5. A method comprising:
determining one or more control points in an image;
determining one or more image manipulation transforms corresponding to each control point; and
providing the one or more control points and the one or more corresponding image manipulation transforms to a user.

6. The method of claim 5, wherein the determining of the one or more control points comprises:
selecting one or more regions in the image; and
associating one or more control points with each selected region.

7. The method of claim 5, wherein the determining of the one or more control points comprises:
selecting one or more regions in the image;
determining a region type for each region; and
associating one or more control points with at least one region based on the region type.

8. The method of claim 5, wherein the determining of one or more of the control points in the image is based on image recognition.

9. The method of claim 5, wherein the one or more image manipulation transforms comprise one or more filters.

10. The method of claim 5, wherein the one or more image manipulation transforms comprise one or more two-dimensional transforms.

11. The method of claim 5, wherein the one or more image manipulation transforms comprise one or more three-dimensional transforms.

12. The method of claim 5, further comprising enabling the user to select one or more of the control points for the image.

13. The method of claim 5, further comprising:
enabling the user to select one or more of the control points for the image; and
enabling the user to select one or more image manipulation transforms for each control point.

14. A system comprising:
one or more processors; and
logic encoded in one or more tangible media for execution by the one or more processors and when executed operable to perform operations comprising:
determining one or more control points in an image;
determining one or more image manipulation transforms corresponding to each control point; and
providing the one or more control points and the one or more corresponding image manipulation transforms to a user.

15. The system of claim 14, wherein to determine the one or more control points, the logic when executed is further operable to perform operations comprising:
selecting one or more regions in the image; and
associating one or more control points with each selected region.

16. The system of claim 14, wherein to determine the one or more control points, the logic when executed is further operable to perform operations comprising:
selecting one or more regions in the image;
determining a region type for each region; and
associating one or more control points with at least one region based on the region type.

17. The system of claim 14, wherein the logic when executed is further operable to perform operations comprising determining the one or more of the control points in the image based on image recognition.

18. The system of claim 14, wherein the one or more image manipulation transforms comprise one or more filters.

19. The system of claim 14, wherein the one or more image manipulation transforms comprise one or more two-dimensional transforms.

20. The system of claim 14, wherein the one or more image manipulation transforms comprise one or more three-dimensional transforms.
